(19) United States
(12) Patent Application Publication
(10) Pub. No.: US 2005/0149365 A1
(43) Pub. Date: Jul. 7, 2005

(54) System and method for automatic conditioning of clinically related billing

(76) Inventor: Timothy Joseph Johnson, Denver, CO (US)

Correspondence Address: SHOOK, HARDY & BACON L.L.P., 2555 GRAND BOULEVARD, KANSAS CITY, MO, 64108-2613, US

(21) Appl. No.: 10/750,322

(22) Filed: Jan. 2, 2004

(51) Int. Cl. G06F 17/60

(52) U.S. Cl. 705/4

(57) ABSTRACT

A system and related techniques capture and regulate the stream of billing items generated in a hospital or other clinical facility for compliance with federal Medicare or other regulatory or other guidelines. In embodiments a conditioning engine may apply rules-based logic or other filters to raw billing information derived from clinical tests, procedures, prescriptions or other patient encounters or care. That raw billing information may be examined for compliance with current regulatory or other guidelines against a compliance database or template, to determine for example whether clinical lab or test records, charts or other necessary documentation exists to support a billed item and satisfy reimbursement guidelines. Billing items whose supporting documentation does not exist or requires further exploration may be conveyed to a holds queue, to hold the billing on those items until documentation may be resolved. Administrators and others may then examine held items for release and bill drop. Because billing items are conditioned to satisfy Medicare or other standards prior to transmission of a bill or invoice, compliance may be assured or significantly enhanced as compared to prior industry practices such as retroactive audits for Medicare compliance.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of management information systems, and more particularly to an integrated platform to capture and condition individual patient charges to ensure compliance with regulatory and/or administrative documentary guidelines.

### BACKGROUND OF THE INVENTION

As the proportion of medical billing satisfied under the federal Medicare and state indigent care (Medicaid) programs increases, the importance of confirming the existence of required documentation used to affirm and support clinical billing practices has grown greater. The Centers for Medicare and Medicaid Services (CMS) mandate a range of charge-level, documentation/affirming data elements that support the appropriate reimbursement of claims by hospitals, physicians and other clinical sites. A broad principle underlying the requirements is that reimbursed care be driven and delivered on a basis of medical necessity. The CMS and other regulations among other things prescribe that adequate clinical documentation and/or affirming data elements exist for delivery of medicines, procedures and other care undertaken for a patient, in part to help establish that medical necessity.

However, many hospitals and other clinical sites do not regularly or comprehensively generate all supporting documentation or affirming data elements required by CMS and other regulatory bodies. This prevailing industry behavior may in part be a result of the fact that existing medical information infrastructure does not or cannot track, generate and associate needed patient documentation to connect that documentation to individual patient charges that are submitted to CMS intermediaries for payment. Certain commercially available tools exist which examine or “scrub” claim forms for internal consistency, for example to ensure erroneous or duplicate codes are not entered. However such packages do not attempt to verify the existence of independent clinical documentation or affirming data elements needed to support the bill or claim, before generating or finalizing the billing item.

Lacking effective or integrated tools, some organizations may therefore rely upon periodic manual audits or samples of patient billing, to retroactively examine compliance with Medicare or other billing guidelines. However, that type of program review merely permits administrators to spot deficiencies in documentation practices after the fact, a shortcoming that is only heightened by the possibility of compliance audits by the department of Health and Human Services (HHS) or other entities.

### SUMMARY OF THE INVENTION

The invention overcoming these and other problems in the art relates in one regard to a system and method for automatic conditioning of individual patient charges, in which charges arising from clinical care are captured and processed in an integrated platform to enforce compliance with Medicare, Medicaid or other regulatory or other documentation/affirming data element requirements. In embodiments, a conditioning engine may receive the raw clinical and billing data and check that data against a compliance documentation/affirming data element template to determine whether necessary support for the item being billed exists. When documentation or support does exist, the billing item may be communicated to further billing platforms to release the bill for subsequent evaluation or to the patient, insurance company or other payor or other entity. Billing items for which documentation/affirming data elements may not be verified or immediately verified may be communicated to a holds queue, from which further or more extensive compliance checking may be carried out. Billing items which may be verified out of the holds queue may be likewise be transmitted in normal course, while items whose documentation cannot be verified may be suspended pending account review or other action. In embodiments the level of desired support to qualify a billing item or other details of that billing event or its compliance may be selected by a billing administrator or otherwise.

### BRIEF DESCRIPTION OF THE DRAWINGS

FIG. 1 illustrates an architecture in which a system and techniques for automatic conditioning of clinically related billing may operate, according to embodiments of the invention.

FIG. 2 illustrates a compliance template, according to embodiments of the invention.

FIG. 3 illustrates a configuration profile managed by a configuration module, according to embodiments of the invention.

FIG. 4 illustrates overall billing processing, according to an embodiment of the invention.

### DETAILED DESCRIPTION OF EMBODIMENTS

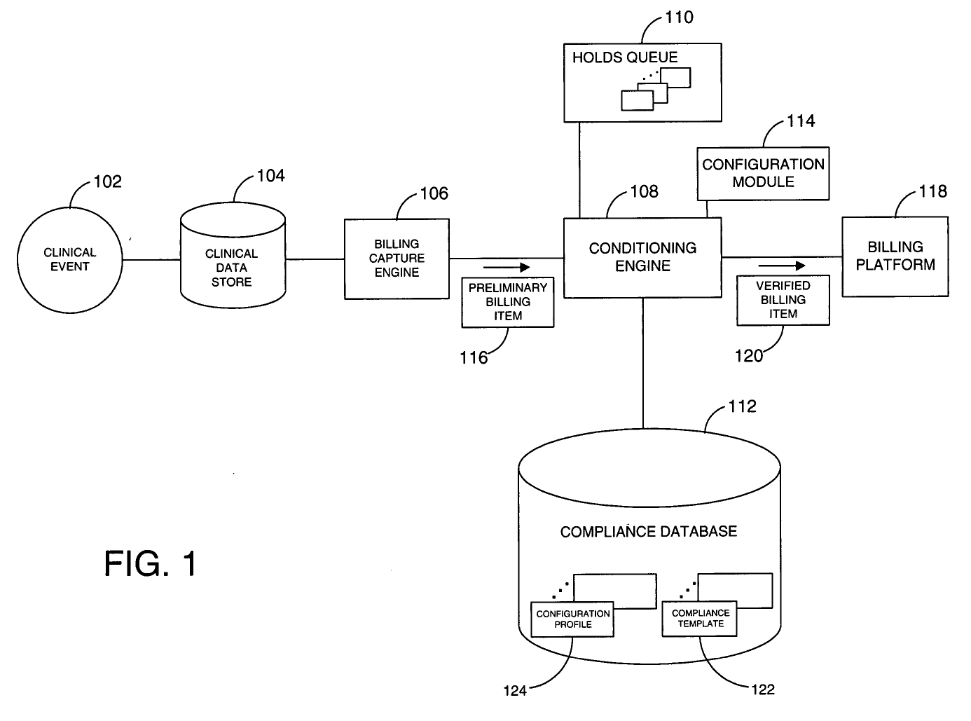

FIG. 1 illustrates an architecture in which a system and method for automatic conditioning of clinically related billing may operate, according to an embodiment of the invention. As illustrated in that figure, in embodiments a clinical event 102 such as an examination, evaluation, surgery or other patient encounter or care may take place, for instance in a hospital, clinic or other site. Details of the clinical event 102 may be captured during or after the delivery of that care or attention and be transmitted to a clinical data store 104, which may be or include for example a database or other data store. The details of the clinical event 102 may include, for example, patient identifying information, insurance account or other information, patient charts, physicians orders, procedure codes, outcomes or other data associated with the clinical attention the patient receives or is scheduled to receive.

In embodiments, the clinical data store 104 may communicate with a billing capture engine 106 to enter and extract billable or potentially billable items or data related thereto, such as pharmaceutical prescriptions, patient supplies, physician services, anesthesiology or radiology services, or other medication, material, supplies or services. Billing capture engine 106 may generate a preliminary billing item 116 as a result of initial data capture and parsing, which item may be or include procedure codes, physician identification, insurance or other coverage data, date or dates of medical encounters or care, or other information supporting or related to the billing of services or materials related to clinical event 102.

According to embodiments of the invention, the preliminary billing item 116 may be transmitted to a conditioning engine 108 to develop and qualify the preliminary billing item 116 under mandatory billing guidelines or other requirements. According to embodiments of the invention in one regard, the conditioning engine 108 may analyze and condition the finalization of preliminary billing item 116 upon compliance with Medicare, Medicaid or other regulatory or other requirements, to ensure that the resulting bill is compliant and payable in the form transmitted. More particularly, upon receipt of preliminary billing item 116, conditioning engine 108 may access a compliance database 112 to compare the recorded procedure codes, medication administration record (MAR), physicians orders or other supporting information related to preliminary billing item 116 to the necessary criteria for Medicare, Medicaid or other public or private entities to accept and pay for that billing item.

According to the invention in one regard, the clinically related billing contained in preliminary billing item 116 or other billing related objects may therefore be prospectively predicated on compliance with those requirements. The chances of generating or transmitting an inadequately supported or noncompliant bill, for example due to lack of demonstrated clinical necessity or on other grounds, may therefore be eliminated or significantly reduced. Collections on transmitted billing items and institutional compliance status may therefore be improved.

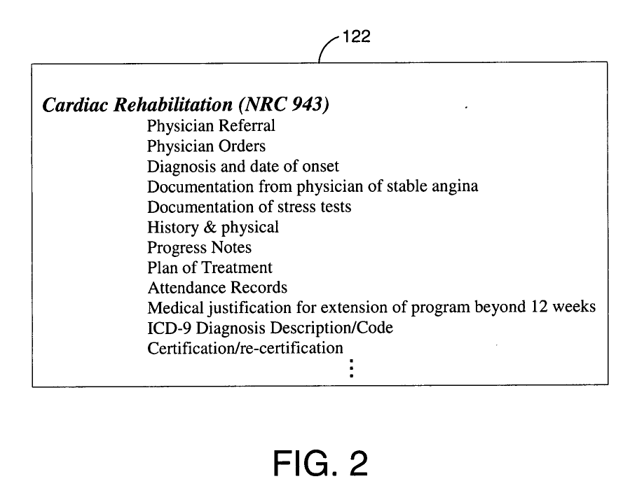

More particularly and as further illustrated in FIG. 1, the conditioning engine 108 may access compliance database 112 and interrogate a compliance template 122 to determine necessary criteria to qualify preliminary billing item 116 under Medicare, Medicaid or other regulations or rules. The compliance template 122, an illustration of which for cardiac related care is shown in FIG. 2, may include data fields for necessary codes, charts, records and other information needed to satisfy those criteria, including, as illustrated, verification of physician referrals, physicians orders, diagnosis and date of onset, diagnostic code, history and physical records, and other data or reports. According to the invention in one regard, and returning to FIG. 1 as illustrated in that figure, the selection and application of data fields or other variables used or applied in compliance template 122 may in embodiments be configured by a billing administrator or others using configuration module 114, for instance using a computer workstation or other client or interface.

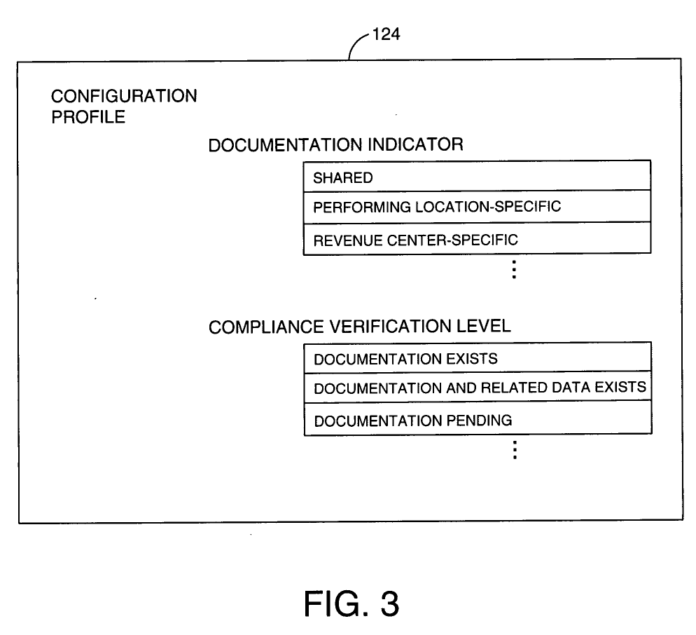

That is, different levels of internal, external or other documentation or affirming data elements necessary to support and satisfy the conditions recorded in compliance template 122 may be adjusted or configured. For instance and as illustrated in FIG. 3, the compliance template may be configured or adjusted in a configuration profile 124 to require that a treatment plan, physicians order or other documentation or information be verified to exist, but affirming data elements in that plan order not be produced, as opposed to the verification of the plan or order and the verification or extraction of all affirming data elements that may be populating that plan or order. Other data fields or status indicators, such as a flag or other field indicating that a report or other documentation or support is pending, may be selected for acceptance depending on implementation or administrative circumstances, such as the availability of other or cooperating data stores or interfaces in the overall management information system. As used herein, “documentation” may refer broadly to any hard copy, electronic, optical or other report, data, file or other media or content, in textual, numeric or other format, which temporarily or permanently reflects or records information related to the delivery of clinical care.

In embodiments the compliance database 112 or one or more compliance templates 122 hosted in compliance database 112 may be generated by government entities such as Medicare, Medicaid, CMS or other entities or bodies, be generated by private companies or others based on public regulatory guidelines or other requirements, or by combinations of those sources for mandatory or other billing guidelines. In embodiments, the compliance database 112 may be accessed by billing administrators or others on a subscription or non-subscription basis, and may in embodiments be updated or extensible according to changing regulations and other conditions.

In embodiments and as shown in FIG. 1, when conditioning engine 108 generates a comparison or analysis of the preliminary billing item 116 against compliance database 112 including any one or more compliance templates 122 which may be selected or used, if the preliminary billing item 116 does not reflect or incorporate or does not fully reflect or incorporate records sufficient to satisfy Medicare, Medicaid or other guidelines, in embodiments an exception may be generated. In that instance the conditioning engine 108 may transmit or convey the preliminary billing item 116 or data related thereto (such as, for example, data fields lacking documentation) to a holds queue 110. The holds queue 110 may be or include local or remote temporary or other storage to receive those billing items or constituent data of those items for which compliance may not be verified, or immediately verified. This may occur for example because a record of physician progress notes terminates at a date too early in the care cycle, a procedure code is missing, incomplete or inconsistent, or for other reasons or grounds. In embodiments, the conditioning engine 108 may apply rules-based logic to determine or assess the completeness or adequacy of a given data field or other information, for instance to locate redundant entries, translate codes from old schemes to new, or perform other logic or tests against the preliminary billing item 116 and its populated data.

The one or more preliminary billing item 116 or related data placed in holds queue 110 may be subjected to further processing and review to validate the documentation and/or affirming data elements for the materials or services to be billed. In embodiments for example, the conditioning engine 108 may automatically communicate with additional, independent, ancillary or other clinical or other data stores to supplement the clinical notations in preliminary billing item 116. Other records or databases, such as insurance, patient supply record, or other data stores may likewise be accessed, for instance to scan for updated or changed patient account numbers, correlate changed or inaccurately recorded patient names, or otherwise extend the survey or search for supporting documentation or affirming data elements for the preliminary billing item 116. In further embodiments, the exceptions trapped in holds queue 110 may be manually or partly manually reviewed by a billing administrator or other user to similarly inspect the clinical data and other sources to satisfy the compliance template 122 or other criteria.

When the evidentiary support for a preliminary billing item 116 residing in holds queue 110 has been satisfactorily verified or supplied, again in embodiments to levels which may be configured in configuration profile 124, the preliminary billing item 116 or related data may be released from holds queue 110 and returned to conditioning engine 108 for release to outbound billing or other processing. In embodiments as shown in FIG. 1, the conditioning engine 108 may therefore generate a verified billing item 120 for transmission to a billing platform 118, which may be or include an internal or external accounts receivable, tracking or other package or platform. In embodiments the verified billing item 120 may include electronic attachments or other annotations of some or all of the supporting documentation used to verify compliance with compliance template 122. In embodiments pointers or links to some or all of that supporting documentation may also be embedded in verified billing item 120, separately or in combination with direct attachments. In cases where further review of exceptions trapped in holds queue 110 does not resolve open compliance issues, in embodiments the preliminary billing item 116 or related data may be removed from holds queue 110, for example to be transferred to a billing administrator for case-by-case recovery review.

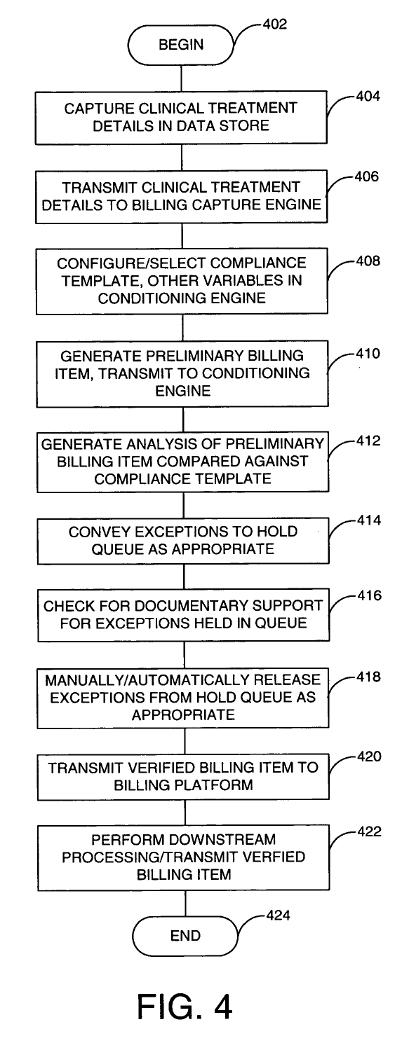

FIG. 4 illustrates overall compliance processing, according to embodiments of the invention. In step 402, processing may begin. In step 404, details of a clinical encounter or encounters, treatment or care may be captured for a patient, and stored to clinical data store 104 or other database. In step 406, the clinical treatment details, such as attending physician, procedure code, pharmaceutical codes or other clinical notations or records may be transmitted to billing capture engine 106. In step 408, a compliance template 122 may be automatically or manually selected or configured, for example via configuration module 114. In step 410, the billing capture engine 106 or other resource may generate a preliminary billing item 116 and transmit that billing record to conditioning engine 108. In step 412, the preliminary billing item 116 may be analyzed by comparison against the compliance template 122 or other filters or data points, for example for compliance with required Medicare, Medicaid or other mandated or other documentation/affirming data elements or support.

In step 414, any exceptions detected from analysis of the preliminary billing item 116 may be communicated to the holds queue 110. In embodiments, billing administrators or others may be notified of the exceptions arriving in or populating holds queue 110, for instance via automated information system workflow, email, voice mail or other messaging or channels. In step 416, the existence of documentation/affirming data elements or other support or evidence sufficient to qualify the one or more preliminary billing items 116 or data from that item may be searched for. In embodiments, that necessary documentation or other evidentiary support, for example patient charts, physician orders or prescriptions, radiology plans or other documents, images, objects or data may be automatically scanned for by conditioning engine 108 and other resources. In further embodiments, clinical, billing or other administrators may manually or partly manually search databases or other data sources to locate the necessary criteria, for instance by reviewing logs or records from radiology, surgery or other departments associated with or performing the related care.

In step 418, the exceptions held in holds queue 110 may be automatically or manually released from that waiting area, when qualifying documentation or other support is confirmed. In step 420, a resulting verified billing item 120 may be transmitted to a billing platform 118, for instance a billing or receivables package or tool. In step 422, any downstream billing processing, such as human spot checks or other verifications or reviews, may be performed and the verified billing item 120 transmitted to the patient, paying party or other recipient, for instance via mail or other channels. In step 424, processing may repeat, return to a prior processing point or end.

The foregoing description of the invention is illustrative, and modifications in configuration and implementation will occur to persons skilled in the art. For instance, while the invention has generally been described in terms of a single conditioning engine that captures and processes a clinical billing stream for compliance, in embodiments the rules or logic applied to enforce documentation and other compliance may be distributed among multiple engines or other resources.

Similarly, while the invention has in embodiments been generally described as examining billing items for compliance with Medicare or Medicaid criteria, the inventive platform may in embodiments apply criteria derived from other federal, state or other commercial, public or private programs. Other hardware, software or other resources described as singular may in embodiments be distributed, and similarly in embodiments resources described as distributed may be combined. The scope of the invention is accordingly intended to be limited only by the following claims.

1. A system for conditioning clinically related billing items, comprising:
an input interface to receive a billing item associated with a clinical event; and
a conditioning engine, the conditioning engine communicating with the input interface to receive the unique billing item and generate a verification of the existence of mandatory documentation or affirming data elements as a condition of transmitting the billing item.

2. A system according to claim 1, wherein the mandatory billing guidelines comprise at least one of regulatory and administrative guidelines.

3. A system according to claim 2, wherein the mandatory billing guidelines comprise at least regulatory guidelines, the regulatory guidelines comprising at least one of Medicare guidelines and Medicare guidelines.

4. A system according to claim 1, wherein the compliance verification performed by the conditioning engine comprises checking evidentiary support for the mandatory documentation or affirming data elements against a compliance template.

5. A system according to claim 4, wherein the evidentiary support comprises at least clinical documentation, the clinical documentation comprising at least one of a patient chart, physicians orders, diagnostic codes, a history and physical record, a medication administration record, a set of progress notes, a treatment plan and a radiology report.

6. A system according to claim 1, wherein the conditioning engine communicates the billing item or data related to the billing item to a holds queue when the verification against the mandatory billing guidelines is not initially satisfied.

7. A system according to claim 6, wherein the billing item or data related to the billing item is further reviewed for satisfaction of the mandatory billing guidelines while in the holds queue.

8. A system according to claim 7, wherein the further review comprises an automated search for additional clinical documentation.

9. A system according to claim 7, wherein the further review comprises an at least partly manual search for additional clinical documentation.

10. A system according to claim 1, wherein the mandatory billing guidelines are stored in a compliance database.

11. A system according to claim 10, wherein the compliance database is updateable.

12. A method for conditioning clinically related billing items, comprising:
receiving a billing item associated with a clinical event; and
generating a verification of the existence of mandatory documentation or affirming data elements against mandatory billing guidelines as a condition of transmitting the billing item.

13. A method according to claim 12, wherein the mandatory billing guidelines comprise regulatory guidelines.

14. A method according to claim 13, wherein the regulatory guidelines comprise at least one of Medicare guidelines and Medicare guidelines.

15. A method according to claim 12, wherein the step of generating a verification comprises checking evidentiary support for the mandatory documentation or affirming data elements against a compliance template.

16. A method according to claim 15, wherein the evidentiary support comprises at least clinical documentation, the clinical documentation comprising at least one of a patient chart, physicians orders, diagnostic codes, a history and physical record, a medication administration record, a set of progress notes, a treatment plan and a radiology report.

17. A method according to claim 12, further comprising a step of communicating the billing item or data related to the billing item to a holds queue when the compliance verification against the mandatory billing guidelines is not initially satisfied.

18. A method according to claim 17, further comprising a step of further reviewing the billing item or data related to the billing item for satisfaction of the mandatory billing guidelines while in the holds queue.

19. A method according to claim 18, wherein the step of further reviewing comprises performing an automated search for additional clinical documentation.

20. A method according to claim 18, wherein the step of further reviewing comprises performing an at least partly manual search for additional clinical documentation.

21. A method according to claim 12, wherein the mandatory billing guidelines are stored in a compliance database.

22. A method according to claim 21, wherein the compliance database is updateable.

23. A clinically related billing item, the clinically related billing item being generated according to a method comprising:
receiving a billing item associated with a clinical event; and
generating a verification of the existence of mandatory documentation or affirming data elements against mandatory billing guidelines as a condition of transmitting the billing item.

24. A clinically related billing item according to claim 23, wherein the mandatory billing guidelines comprise regulatory guidelines.

25. A clinically related billing item according to claim 24, wherein the regulatory guidelines comprise at least one of Medicare guidelines and Medicare guidelines.

26. A clinically related billing item according to claim 23, wherein the step of generating a verification comprises checking evidentiary support for the mandatory documentation or affirming data elements against a compliance template.

27. A clinically related billing item according to claim 26, wherein the evidentiary support comprises at least clinical documentation, the clinical documentation comprising at least one of a patient chart, physicians orders, diagnostic codes, a history and physical record, a medication administration record, a set of progress notes, a treatment plan and a radiology report.

28. A clinically related billing item according to claim 23, wherein the method further comprises a step of communicating the billing item or data related to the billing item to a holds queue when the compliance verification against the mandatory billing guidelines is not initially satisfied.

29. A clinically related billing item according to claim 28, wherein the method further comprises a step of further reviewing the billing item or data related to the billing item for satisfaction of the mandatory billing guidelines while in the holds queue.

30. A clinically related billing item according to claim 29, wherein the step of further reviewing comprises performing an automated search for additional clinical documentation.

31. A clinically related billing item according to claim 29, wherein the step of further reviewing comprises performing an at least partly manual search for additional clinical documentation.

32. A clinically related billing item according to claim 23, wherein the mandatory billing guidelines are stored in a compliance database.

33. A clinically related billing item according to claim 32, wherein the compliance database is updateable.
